(19) United States
(12) Patent Application Publication
(10) Pub. No.: US 2023/0161953 A1
(43) Pub. Date: May 25, 2023

(54) Automated Job Application Completion and Submission System (AJACSS)

(71) Applicant: John D'Uva, Tinton Falls, NJ (US)

(72) Inventor: John D'Uva, Tinton Falls, NJ (US)

(21) Appl. No.: 18/057,998

(22) Filed: Nov. 22, 2022

Related U.S. Application Data
(60) Provisional application No. 63/282,680, filed on Nov. 23, 2021.

(51) Int. Cl. G06F 40/174; G06F 16/951; G06F 3/0482

(52) U.S. Cl. CPC G06F 40/174; G06F 16/951; G06F 3/0482

(57) ABSTRACT

Disclosed is a computer program that contains a method for identifying/storing job information while crawling companies' online job listings, an interface for filtering out jobs that a user is not interested in applying to, and a method for populating/submitting job applications using previously stored user information. This system centralizes and automates all the time-intensive, repetitive tasks that are required when applying to jobs online.

### CROSS-REFERENCES TO RELATED APPLICATIONS

This application claims the benefit of priority of the U.S. Provisional Application No. 63/282,680 titled “Automated Job Application Completion and Submission System (AJACSS)” and filed on Nov. 23, 2021, which is herein incorporated by reference in its entirety for all purposes.

### STATEMENT AS TO RIGHTS TO INVENTIONS MADE UNDER FEDERALLY SPONSORED RESEARCH AND DEVELOPMENT

Not Applicable

### REFERENCE TO SEQUENCE LISTING, TABLE, OR COMPUTER PROGRAM

Not Applicable

### BACKGROUND

The present invention relates to computer software and, more specifically, to a technique for centralizing and automating the online job application process. Applying to jobs online is extremely repetitive and time-consuming, as many applications often include the exact same questions. There is also an excessive amount of clicking, page crawling, and tab opening while searching for positions on a company's careers site. These inconveniences often lead to job seekers sending multiple applications to the same job, missing relevant jobs, or losing their place within the list of jobs. Furthermore, it can be difficult for individuals to know which companies to apply to if they are about to graduate, change industries, or move to a new location.

Steps have been taken to try to improve the online job application process but the existing art falls well short of what can be achieved. Browser extensions for auto-filling some simple forms exist but only handle the most basic information. Users must still navigate each page to submit each application. Parsers used by job-hosting sites to extract info from a resume are often ineffective at what they claim to do and usually return forms riddled with errors. Users must still manually navigate each page to submit each application. Currently, the most effective/efficient job application process among the existing art is LinkedIn Corporation's “Easy Apply” option which requires only a few clicks to apply. However, that designation is only available for a small percentage of jobs and those jobs must be approved by the hiring company for the “Easy Apply” option. Users must still manually navigate each job to submit each application. None of the aforementioned methods have the capacity to automate application submissions and they remain extremely tedious/time-consuming for users.

### BRIEF SUMMARY OF INVENTION

AJACSS centralizes and automates all the time-intensive, repetitive tasks that are required when applying for jobs online. The user creates their account, inputs their information only once, and then navigates within a single interface where they can filter jobs by a series of features: location, level of experience, industry, company, etc. Users then have the option to further filter this subset of jobs by typing in keywords of interest. Once the entire job list is filtered down, the user can scroll through the remaining positions and review each job's title, location, and company. If this basic information is sufficient for a user to want to apply, they can click the checkbox to the left of the job listing. If they require more information, they can click on the “Preview Job Description” button to the right of the job listing which will load the URL for the job description's webpage inside the current browser window (adjacent to the list of jobs). Once all jobs of interest are selected, the user clicks the “Apply to Jobs” button at the bottom of the window and the software handles the rest. The program starts crawling the webpages where the selected jobs are hosted, automatically filling out each application according to the user's data and submitting the application on behalf of the user. The system also catalogues which jobs the user has applied to in a database to prevent repetition.

### BRIEF DESCRIPTION OF THE DRAWINGS

FIG. 1: Flowchart of a user navigating the job application interface.

FIG. 2: An example of the user interface after the filtering stage.

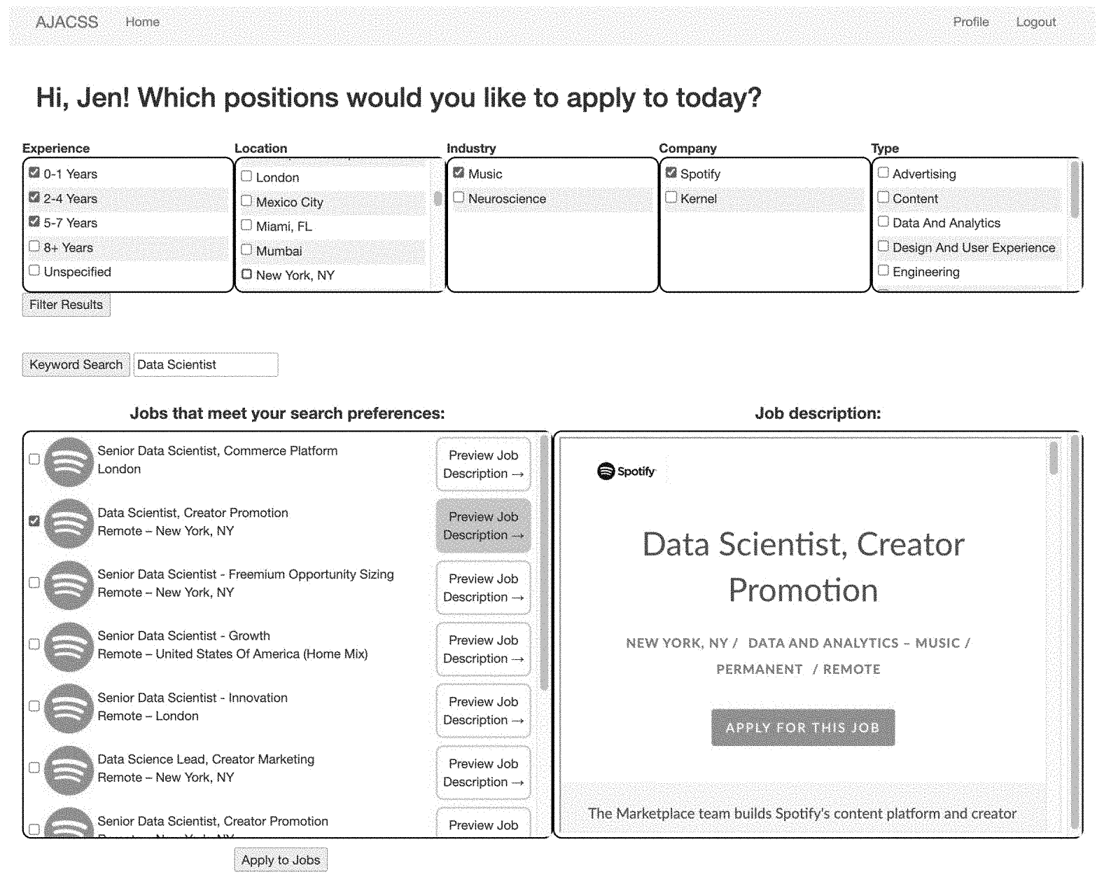

### DETAILED DESCRIPTION AND BEST MODE OF IMPLEMENTATION

Before the process of crawling job listings can begin, preparation for that process can begin by creating/updating a database that contains the following tables:
‘Companies’
‘Jobs’
‘Users’
   The ‘Companies’ table is updated semi-manually by a developer through the backend anytime there is desire to add a new company to the system. This company's record will contain its:
name
URL
industry
unique identification number
   The code for crawling and form-filling the job applications (described later) will need to be updated almost every time that a record is added to the ‘Companies’ table so that it can handle elements in the HTML that may have subtle differences, such as element names, CAPTCHA methods, XPATHS, etc.

Once a new company has been added to the ‘Companies’ table, the ‘Jobs’ table can be updated automatically/programmatically by crawling the URL stored in the Company record. This URL will point directly toward the company's careers page where the open positions are listed. The crawler will parse each job description and create a new record in the lobs' table by assigning a unique job identification number and identifying the following information:
title
location
type/department
associated company ID from ‘Companies’ table
URL
experience level
   Of these, the experience level is the only feature that is non-trivial to identify. However, this task has been accomplished with ˜95% accuracy by using an extensive regular expression that searches the HTML text for numeric characters that are followed by (variations of) the word “years.” From the limited research performed at the time of writing, an estimated 80% of job descriptions contain a reference to “years of experience required”, making this a highly effective feature for users when they're filtering the data. These job records are programmatically reviewed at least once a day to keep the table up to date. If a URL no longer returns an active webpage/job description, the record is removed from the table.

The ‘Users’ table is only updated manually through the frontend by users as they either sign up initially or edit their saved information through the website. Each user's record in the table contains:
username
email
password hash
resume
first and last name
phone number
URL to LinkedIn, GitHub, and/or portfolio
user's answers to commonly asked questions

Once these tables are established, a user can create an account and begin filtering the full list of jobs down to only the jobs of interest. If no filters are selected and no keywords are input, the logic returns all jobs in the database. The list of jobs shown to the user will update once the user either (a) selects at least one filter and clicks the “Filter Results” button or (b) enters text into the “Keyword Search” form and clicks the associated button. The “Keyword Search” method can be programmed to match against all job features (location, industry, etc.) or only the job titles. More research will need to be done to determine which method would best reflect users' intent most often. The “Filter Results” method searches through the records in the ‘Jobs’ table of the database and only returns records that match the filter(s) chosen. The ‘Preview Job Description’ button simply pulls the URL from the associated job record in the database and loads the page in the adjacent window for easy and convenient viewing. As the user reviews these job listings, they will click the checkboxes next to the jobs that they want to apply to.

Once all jobs of interest have been selected, clicking the “Apply to Jobs” button begins the automated application process. This loop opens each job's URL and begins filling out the application in the same manner that a human would. There are plenty of existing code libraries that simplify the processes of web crawling and form-filling, but what makes these tasks complicated in this context is that most companies have different element names and XPATHS for their forms. For example, referencing the resume upload form isn't always as trivial as looking for the element with the “resume” tag. Sometimes its name is “CV”, “res”, or it may even be a string of seemingly random characters. If any elements are referenced by XPATHs, such paths could be dramatically different. As mentioned in paragraph [0009], the logic for form-filling will need to be updated every time that a new company is added to the ‘Companies’ table so that it can handle the aforementioned elements in the HTML that may be different.

Once all the forms on the job application are filled out, it is common for host sites to perform a Turing test in the form of a CAPTCHA before users can submit their application. In the same manner that the logic must account for different companies having different element names, the logic must also account for different kinds of CAPTCHA tests (such as reCAPTCHA, hCaptcha, Text captcha, etc.). These tests act as digital speedbumps to prevent ill-intentioned submissions from overwhelming the host server. While AJACSS can use existing services (such as 2Captcha) to automatically solve these Turing tests, it has no intention of behaving in a malicious manner. To take further precaution, the logic sorts/optimizes the list of jobs such that applications to the same company are as far apart from each other as possible. For example, instead of applying to companies in the order [A, A, A, B, B, B, C, C, C], the system will apply in the order [A, B, C, A, B, C, A, B, C] to maximize time between page requests to the same site. If a user only wants to apply to a single company during a session, a programmatic pause is taken between submissions to prevent excessively high request rates.

While looping through job applications, it is likely that the crawler will encounter an application that includes a form/question requesting information that was not originally collected by AJACSS during account creation. In such cases (identified by a failed submission), the job in question will be moved into a separate list to be reviewed after all other standard applications have been successfully submitted. At that point, the system will identify the specific forms/questions that failed within this new list of jobs and request a manual response from the user for these unanswered questions. The user has the option to (a) answer the question and apply to the job, or (b) ignore the question and skip the job. In the case of the former, the system will save this response to the user's database record and inform the developer that a new company-specific question needs to be added to the “Profile” page. Other existing users will be notified when a new question is added so that they can update their profiles accordingly. The user-interface for the “Profile” page will group company-specific questions under company-specific headers. For example, if Company A's applications now include the question, “Why do you want to work at Company A?”, that question will now be listed on the “Profile” page under the header, “Company A.” It will also list the titles of jobs that include the question, as well as the total number of jobs that include the question. This will allow users to easily navigate through the various companies and only answer subsequent questions for companies that they plan to apply to.

1. A method for identifying and storing job information while crawling companies' online job listings.

2. An interface comprising:
(a) selectable options and a keyword-input form for setting filter criteria, and
(b) a scrollable list of jobs that meet said criteria, and
(c) buttons for displaying entire job descriptions, and
(d) checkboxes to select jobs of interest, and
(e) a button to begin the automated application process.

3. A method for automatically filling out forms on job applications using stored user information and submitting the applications back to the hiring companies.
